(19) United States
(12) Patent Application Publication
(10) Pub. No.: US 2006/0129667 A1
(43) Pub. Date: Jun. 15, 2006

(54) Method of and system for sharing access to cluster of computers

(76) Inventor: Eric Anderson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/009,339

(22) Filed: Dec. 10, 2004

(51) Int. Cl. G06F 15/173

(52) U.S. Cl. 709/223

(57) ABSTRACT

A method of sharing access to a cluster of computers begins with a step of identifying a particular user from within a group of users. The method continues with a step of loading a particular virtual node onto a first computer. The particular virtual node comprises one of a plurality of virtual nodes for the group of users. Each of the plurality of virtual nodes comprises an operating system selected from a range of operating systems and one or more applications. The method continues with a step of operating the particular virtual node which changes a node state, thereby forming a modified state. The method concludes with a step of suspending the particular virtual node which saves the modified state, closes the virtual node, and idles the first computer. A computer system that provides time-shared exclusive access to users comprises computers, a shared storage, and a node manager. In operation, a user selects a computer causing the node manager to load a disk image of the virtual node from the shared storage onto a local storage. The user operates the virtual node modifying its state. The user releases the computer causing the node manager to transfer the disk image in the modified state to the shared storage.

### FIELD OF THE INVENTION

The present invention relates to the field of computers. More particularly, the present invention relates to the field of computers where users share computers over time.

### BACKGROUND OF THE INVENTION

In time-shared exclusive access to a cluster of computers, users are able to log onto an available computer and later log off the computer. While a particular user is logged onto a particular computer, another user who wishes to operate one of the computers must find some other computer which is not being used. An example of the time-shared exclusive access to a cluster of computers is a computer lab at a school. Typically, the computer lab will have anywhere from a few computers to dozens of computers. A student wishing to operate one of the computers finds an available computer and logs onto the computer. Later, after accomplishing his or her tasks, the student logs off the computer.

There have been a number of approaches to time-shared exclusive access to clusters of computers. In high performance computing, the approach is typically to provide exclusive performance access but to deny the user an ability to change applications or operating systems on a computer. This approach limits system flexibility to users who may wish to change applications or operating systems.

In a utility data center, a controller configures VLAN (virtual local area network) and SAN (storage area network) switches to connect servers to partitions within a storage array (i.e., one or more disk arrays). The servers and the storage array may support a commercial web application. Within a particular commercial web application, the servers are arranged in tiers. Each tier comprises a server and a partition of the storage array so that the partition forms the storage media for the server. The partition contains the operating system and the applications for the server. While the utility data center makes efficient use of resources for applications requiring the reliability of a shared storage array, a more efficient solution for less demanding environments would be beneficial.

Another approach uses diskless clients which connect to a central server via a LAN. This approach suffers from bandwidth and capacity constraints imposed by the LAN and the central server.

Yet another approach uses a master image which is downloaded to a group of computers. The master image includes an operating system and one or more applications. This approach makes slight modifications to the master image on a particular computer to handle differences in IP (Internet protocol) addresses, hostnames, etc. This approach suffers from an inability to retain changes to the master image when the master image is reloaded or updated.

### SUMMARY OF THE INVENTION

According to an embodiment, the present invention comprises a method of sharing access to a cluster of computers. According to an embodiment, the method begins with a first step of identifying a particular user from within a group of users. The method continues with a second step of loading a particular virtual node onto a first computer. The particular virtual node comprises one of a plurality of virtual nodes for the group of users. Each of the plurality of virtual nodes comprises an operating system selected from a range of operating systems and one or more applications. The method continues with a third step of operating the particular virtual node which changes a node state, thereby forming a modified state. The method concludes with a fourth step of suspending the particular virtual node which saves the modified state, closes the virtual node, and idles the first computer.

According to another embodiment, the present invention comprises a computer system that provides shared access to users. According to an embodiment, the computer system comprises a plurality of computers, a shared storage, and a node manager. The plurality of computers couples to the shared storage and the node manager. Each computer comprises a local storage. In operation, a particular computer begins in an idle mode. A user selects the particular computer causing the node manager to load a disk image of a virtual node from the shared storage onto the local storage. In an embodiment, the virtual node comprises an operating system and an application. In another embodiment, the virtual node comprises the operating system and a plurality of applications. In yet another embodiment, the virtual node comprises the operating system, one or more applications, and one or more configuration parameters. The user operates the virtual node which modifies a node state, thereby forming a modified state. Eventually, the user releases the particular computer causing the node manager to transfer the disk image of the virtual node in the modified state to the shared storage.

These and other aspects of the present invention are described in more detail herein.

### BRIEF DESCRIPTION OF THE DRAWINGS

The present invention is described with respect to particular exemplary embodiments thereof and reference is accordingly made to the drawings in which:

FIG. 1 schematically illustrates an embodiment of a computer system of the present invention that provides time shared access to users; and

FIG. 2 illustrates an embodiment of a method of providing time shared access to a cluster of computers of the present invention as a flow chart.

### DETAILED DESCRIPTION OF A PREFERRED EMBODIMENT

According to an embodiment, the present invention comprises a computer system that provides time shared access to users who can choose different operating systems, conflicting applications, conflicting configuration options, or a combination thereof. According to another embodiment, the present invention comprises a method of sharing access to a cluster of computers in which users can choose different operating systems, conflicting applications, conflicting configuration options, or a combination thereof.

The conflicting applications may be written for the different operating systems. For example, if a first user chooses a Unix operating system and a second user chooses a Microsoft® Windows® operating system, the first user cannot use the second user's wordprocessing application and vice versa. Alternatively, the conflicting applications may be written for a particular operating system but cannot be simultaneously installed. For example, normally, Microsoft® Word 2000 and Word 2003 cannot be simultaneously installed since the installation process for Word 2003 replaces Word 2000. The conflicting configuration options comprise choices made by one or more users which are mutually exclusive. For example, if a first user changes a default word-processing page format for a word-processing application and a second user does not, each user is given a different word-processing default page format upon opening the word-processing application. Or, for example, a first user may tune a database application for OLTP (on-line transaction processing) and a second user may tune the database application for decision support.

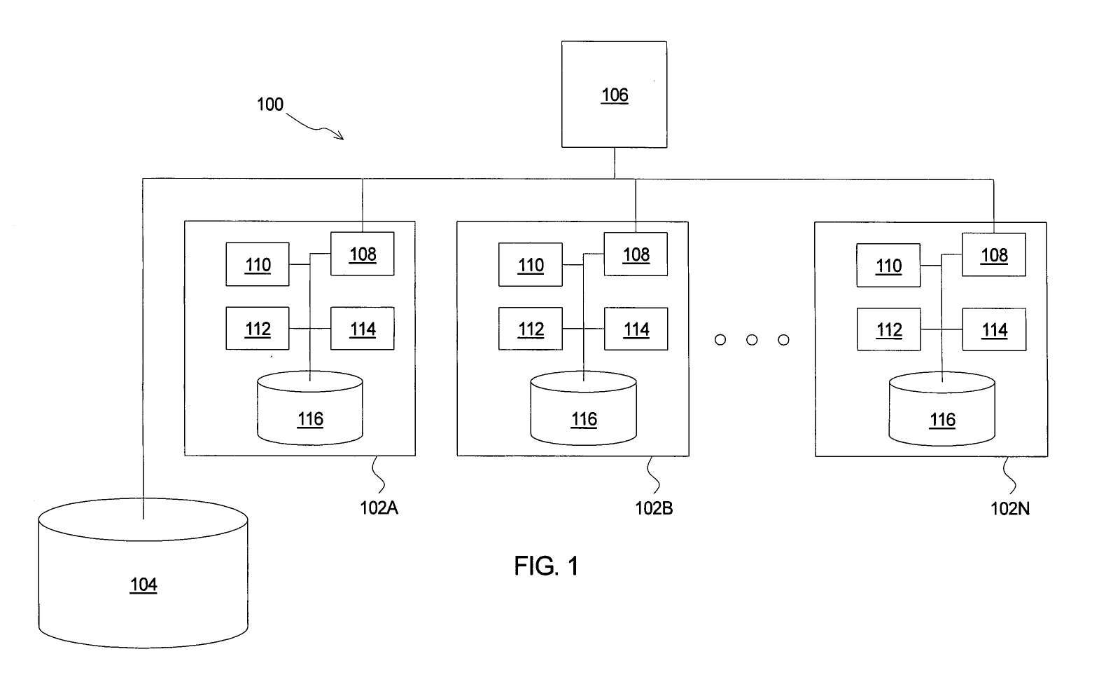

An embodiment of a computer system which provides timed shared access to users is illustrated schematically in FIG. 1. The computer system 100 comprises a plurality of computers, 102A, 102B, . . . , 102N, a shared storage 104, and a node manager 106. The plurality of computers, 102A, 102B, . . . , 102N, couple to each other and to the shared storage 104 and the node manager 106.

According to an embodiment, each of the plurality of computers, 102A, 102B, . . . , 102N, comprise a network interface 108, a processor 110, a memory 112, input/output 114, and a local storage 116. According to an embodiment, the plurality of computers, 102A, 102B, . . . , 102N, comprise a homogeneous cluster of computers. According to another embodiment, the plurality of computers, 102A, 102B, . . . , 102N, comprise a heterogeneous cluster of computers in which component specifications vary among the plurality of computers, 102A, 102B, . . . , 102N. According to this embodiment, the network interfaces 108, the processors 110, the memory 112, the input/output 114, the local storage 116, or a combination thereof between any two of the plurality of computers, 102A, 102B, . . . , 102N, can differ. Preferably, the local storage 116 for the plurality of computers, 102A, 102B, . . . , 102N, comprises a disk drive. Alternatively, the local storage 116 for the plurality of computers, 102A, 102B, . . . , 102N, comprises another storage media such as a tape drive or flash memory.

According to an embodiment, the shared storage 104 comprises a disk array. According to another embodiment, the shared storage 104 comprises a SAN (storage area network). According to another embodiment, the shared storage 104 comprises a node having an internal or external disk drive.

According to an embodiment, the node manager 106 comprises a stand-alone computer. According to another embodiment, the node manager 106 comprises a virtual node of one of the plurality of computers, 102A, 102B, . . . , 102N.

In operation, a first user selects a first computer 102A. The first user may select the first computer in a number of ways. For example, the user may select the first computer by logging-on, clicking an object on a web site, making a selection from an interface to an application (e.g., selecting a menu item), or providing a physical object to a physical object reader. Examples of providing the physical object to the physical object reader include providing an identification badge to a badge reader and providing a biometric attribute (e.g., an iris, a retina, a finger print, or a voice sample) to an appropriate biometric scanner.

In response to the selection of the first computer 102A by the first user, the node manager 106 responds by loading a first virtual node belonging to the first user onto the first computer 102A. In an embodiment, the first virtual node comprises an operating system and an application for the first user. In another embodiment, the first virtual node comprises the operating system and a plurality of applications for the first user. In yet another embodiment, the first virtual node comprises the operating system, one or more applications, and one or more configuration parameters for the first user.

The operating system comprises a selection from a range of operating systems such as Linux, Microsoft Windows, or Unix. The application or applications comprise one or more particular application packages chosen by the user. An administrative virtual node could comprise just an operating system. This administrative virtual node could form a starting point for an administrator configuring a particular virtual node for a particular user. The one or more configuration options comprise choices made by a user such as a tuning parameter (e.g., a speaker volume) or a change to a default option (e.g., a word-processing default page format).

In an embodiment, loading of the first virtual node onto the first computer 102A comprises copying a disk image comprising the operating system and the one or more applications and the one or more configuration options from the shared storage 104 onto the local storage 116 for the first computer 102A.

The first user operates the first computer 102A changing a node state for the first virtual node. Initially, the node state comprises the operating system and the application or applications as well as possibly the one or more configuration options. As time goes by and the first user accesses the first virtual node, the first user changes the node state to accommodate among other things at least one configuration option chosen or adjusted by the first user or at least one new application package added to the first virtual node. Other changes that the user may make to the node state include having at least one application package open or having at least one file open. Thus, in any particular operation period, the first user can change the node state, thereby forming a modified node state.

After a time, the first user releases the first computer 102A which suspends the virtual node. The first user may release the first computer 102A by shutting down the first computer. Upon releasing the first computer 102A, the node manager 106 saves the modified node state, closes the virtual node, and idles the first computer 102A. In an embodiment, the node manager 106 saves the virtual node by transferring the disk image from the local storage 116 to the shared storage 104. The node manager 106 may save the virtual node using a suspend-to-disk operation.

A number of techniques are available for minimizing transfer time of the disk image between the first computer 102A and the shared storage 104. In an embodiment, the first computer 102A compresses the disk image before it is transferred from the local storage 116 of the first computer 102A to the shared storage 104. Compressing the disk image reduces network traffic and conserves network bandwidth. In an embodiment of compressing the disk image, a time to compress the disk image is balanced against a time to transfer the compressed disk image. According to this embodiment, if network transfer time is low and the time to fully compress the disk image is high, it is preferable to perform minimal compression of the disk image. Alternatively, if network transfer time is high and the time to fully compress the disk image is low, it is preferable to fully compress the disk image.

In an embodiment of storing the disk image onto the shared storage 104, only non-patterned bit segments are transferred from the local storage 116 of the first computer 104A to the shared storage 104. The non-patterned bit segments are ones in which no regular, predictable pattern of ones, zeros, or a combination thereof appears. In contrast, regular pattern bit segments are segments of data in which all the bits have a regular, predictable pattern such as all ones, all zeros, repeating bits on a byte or word basis, or a counting sequence of bits. In another embodiment, the local storage 116 of any of the plurality of computers that is in an idle mode has its available storage space set to a uniform bit state (i.e, zeros or ones are written across the available storage space). For example, the available storage may be available storage in an allocated file system. Or, for example, the available storage may be available storage in one or more disks or available storage in a database. According to this embodiment, when the disk image is transferred to the local storage 116, only non-patterned bit state information is transmitted. The regular pattern bit state is written across the local storage 116 in anticipation of another virtual node being loaded onto the first computer 102A so that only the non-patterned bit state information is transmitted and written onto the local storage 116. According to an embodiment, the first computer 102A only transfers a state change to the shared storage 104 upon suspension of the first virtual node. The first computer 102A may choose a regular pattern so that the state change or disk image compresses well. Upon compressing the state change, the first computer 102A may choose to transfer the uncompressed state change rather than the compressed state change.

A number of techniques are available for minimizing use of storage space on the shared storage 104. According to an embodiment, the shared storage 104 dynamically recompresses the compressed disk image before storing it. According to an embodiment, if multiple disk images have identical blocks of data, the shared storage 104 stores a single copy of the identical blocks of data and stores pointers for the disk images that include one or more of the identical blocks of data. According to an embodiment, the shared storage 104 stores state masters for each of the available operating systems and application packages. According to this embodiment, the shared storage also stores state deltas for each of the virtual nodes which indicate the changes made to the state relative to a state master or another delta. The state change may be provided as a list of offsets and new data where each of the offsets provides the location for a portion of the new data. According to an embodiment in which a user selects a particular computer and operates the particular computer for an extended period of time, the shared storage 104 does not retain a copy of the disk image while the disk image is stored on a local storage 116.

In an embodiment, each suspension of a virtual node stores a modified state delta on the shared storage 104. According to this embodiment, previous modified state deltas are maintained so that if a particular user wants to recall a virtual node in a previous node state it can be accomplished by accessing the previous modified state delta.

Before, during, or after the first user accesses the first computer 102A, a second user selects a second computer 102B. The node manager 106 responds by loading a second virtual node belonging to the second user onto the second computer 102B. The second virtual node comprises an operating system, one or more applications, and possibly one or more configuration options for the second user. The second user then operates the second computer 102B possibly changing its node state and, then, releases the second computer 102B.

At some later time, the first user selects the second computer 102B causing the node manager 106 to load the first virtual node onto the second computer 102B. In an embodiment, the first virtual node comprises a Linux operating system with Linux compatible applications and the second virtual node comprises a Microsoft Windows operating system with Microsoft Windows compatible applications. In another embodiment, the first and second virtual nodes comprise a Microsoft Windows operating system with a Microsoft Word word-processor. In this embodiment, the first virtual node has a standard default Word page while the second virtual node has a custom default Word page. Thus, the present invention allows multiple users of a cluster of computers to operate any of the computers with conflicting operating systems or conflicting applications or conflicting configuration options or a combination thereof.

According to an embodiment in which the second computer 102B is on a different network from the first computer 102A (e.g., different LANs coupled by a wide area network), when the first user selects the second computer 102B, the node manager 106 directs the second computer 102B to reconfigure a virtual private network for the second computer 102B. According to this embodiment, the connectivity perceived by the first user while using the second computer 102B is similar to the connectivity that the first user experienced when previously using the first computer 102A. According to another embodiment in which the second computer 102B is on a different network from the first computer 102A, DHCP (dynamic host configuration protocol) provides an updated address for the second computer 102B so that the first user experiences a similar connectivity to the connectivity experienced by the first user when previously using the first computer 102A.

According to an alternative embodiment, one or more of the plurality of computers, 102A, 102B, . . . , 102N, includes a service processor in addition to the processor 110. The service processor provides a capability of suspending the processor 110, which improves flexibility as to when a virtual node can be loaded or suspended.

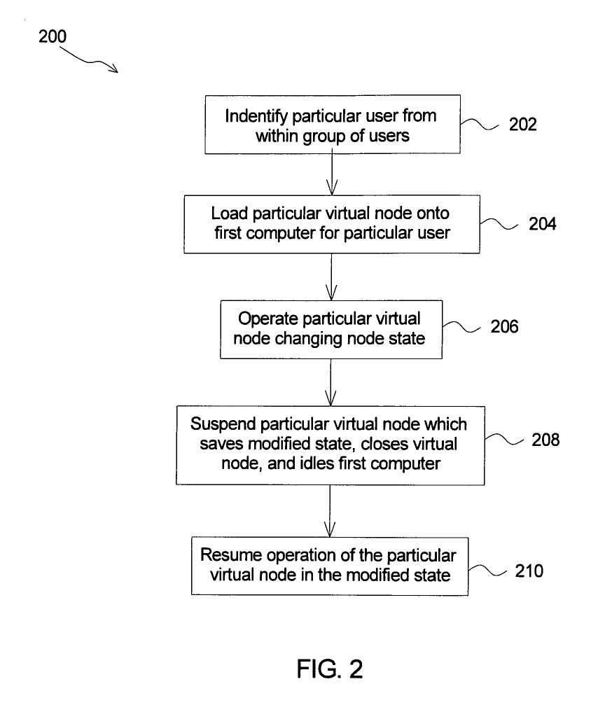

An embodiment of a method of sharing access to a cluster of computers of the present invention is illustrated as a flow chart in FIG. 2. The method 200 begins with a first step 202 of identifying a particular user from within a group of users. In a second step 204, the method loads a particular virtual node onto a first computer. The particular virtual node comprises one of a plurality of virtual nodes for the group of users. Each of the plurality of virtual nodes comprises an operating system selected from a range of operating systems and one or more applications. The particular virtual node has a node state. The node state comprises an operating system, one or more applications, and possibly one or more configuration options for the particular user.

A third step 206 operates the virtual node, which changes the node state and thereby forms a modified state for the virtual node. In an embodiment, the method 200 concludes with a fourth step 208 of suspending the virtual node which saves the modified state, closes the virtual node, and idles the first computer. A node manager may control the first through third steps, 202 . . . 206, of loading the virtual node, operating the virtual node, and suspending the virtual node.

The computer upon which the first through third steps, 202 . . . 206, are performed may employ a trusted computing module to verify transitions occurring within the first through third steps, 202 . . . 206. Preferably, the trusted computing module meets standards put forth by the Trusted Computing Group, an industry standards body.

In an embodiment, the second step 204 includes transferring a disk image from a shared storage media onto a local storage media of the first computer. In this embodiment, the fourth step 208 of suspending the virtual node may include saving the modified state on the shared storage media. Alternatively, the fourth step 208 of suspending the virtual node may include saving a modified disk image on the shared storage in which the modified disk image includes the modified state. Or, the fourth step 208 of suspending the virtual node may identify state changes between the node state and modified state and transferring the state changes to the shared storage.

In an embodiment in which the modified disk image is saved on the shared storage, the fourth step 208 of suspending the virtual node may include compressing the modified disk image to form a compressed disk image and saving the compressed disk image on the shared storage. In such an embodiment, a compression time for compressing the modified disk image may be balanced against a transfer time for transferring the modified disk image to control the amount of compression of the modified disk image. Here, a dynamic re-compression may be employed at the shared storage which completes compression of the modified disk image before storing it on the shared storage.

In an embodiment in which the fourth step 208 transfers the modified state to the shared storage, a further step of setting bits to regular pattern state on at least a portion of the local storage may be employed. For example, the bits may be set to zero. Alternatively, the bits may be set to one or the bits may be set to a pattern of ones and zeros. In this embodiment, re-loading the first virtual node or loading another virtual node on the first computer may include not writing particular bits within a disk image to the local storage which have the uniform state.

In an embodiment, the fourth step 208 of suspending the virtual node comprises storing a modified state delta on the shared storage. The modified state delta comprises the differences between the modified state for the virtual node and a base state for a group of virtual nodes. In this way, when the virtual node is reloaded, the base state and the modified state delta may be transferred from the shared storage to the computer upon which the virtual node is being reloaded.

In an embodiment, the method 200 further comprises a fifth step 210 of resuming operation of the virtual node in the modified state. For example, the fifth step 210 may reload the virtual node onto the first computer. Alternatively, the fifth step 210 may load the virtual node onto a second computer. If the fifth step 210 loads the virtual node onto the second computer, a sixth step of reconfiguring a virtual private network for the second computer may be employed which provides a user perceived connectivity similar to the connectivity provided by the first computer.

According to an embodiment of the method 200, the particular virtual node is a first virtual node which includes a first operating system, first applications, and first configuration options for a first user, the node state is a first node state, and the modified state is a first modified state. In an embodiment, the method 200 further comprises the steps loading a second virtual node onto a second computer, operating the second virtual node, and suspending the second virtual node. The second virtual node includes a second operating system, second applications, and second configuration options. The step of operating the second virtual node may change a second node state thereby forming a second modified state. The step of suspending the second virtual node saves the second modified state, closes the second virtual node, and idles the second computer.

The first and second operating systems may be the same operating system or may be different operating systems. The first applications may include a first particular application which conflicts with a second particular application of the second applications. Alternatively, the first and second particular applications may include conflicting tuning parameters.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A method of sharing access to a cluster of computers comprising the steps of:
identifying a particular user from within a group of users;
loading a particular virtual node for the particular user onto a first computer, the particular virtual node comprising one of a plurality of virtual nodes for the group of users, each of the plurality of virtual nodes comprising an operating system selected from a range of operating systems and one or more applications;
operating the particular virtual node which changes a node state, thereby forming a modified state; and
suspending the particular virtual node which saves the modified state, closes the virtual node, and idles the first computer.

2. The method of claim 1 wherein the particular virtual node further comprises one or more configuration options.

3. The method of claim 1 wherein a node manager controls the steps of loading the particular virtual node onto the first computer and suspending the virtual node.

4. The method of claim 1 further comprising the step of resuming operation of the particular virtual node, the particular virtual node comprising the modified state.

5. The method of claim 4 wherein the step of resuming operation of the particular virtual node comprises loading the virtual node onto a second computer.

6. The method of claim 5 further comprising the step of reconfiguring a network for the second computer which provides the second computer with a user perceived connectivity similar to the first computer.

7. The method of claim 1:
wherein the particular virtual node comprises a first virtual node which comprises a first operating system and one or more first applications for the particular user, the node state comprises a first node state, and the modified state comprises a first modified state; and
further comprising the steps of:
loading a second virtual node onto a second computer, the second virtual node comprising a second operating system and one or more second applications for a second user;
operating the second virtual node which changes a second node state, thereby forming a second modified state; and
suspending the second virtual node which saves the second modified state, closes the second virtual node, and idles the second computer.

8. The method of claim 7 wherein the first and second operating systems comprise different operating systems.

9. The method of claim 7 wherein the one or more first applications comprise a first particular application and the one or more second applications comprise a second particular application.

10. The method of claim 9 wherein the first and second particular applications comprise conflicting applications.

11. The method of claim 9 wherein the first and second particular applications comprise conflicting configuration options.

12. The method of claim 1 wherein the step of loading the particular virtual node onto the first computer further comprises transferring a disk image from a shared storage media onto a local storage media of the first computer.

13. The method of claim 12 wherein the step of suspending the particular virtual node saves the modified state on the shared storage media.

14. The method of claim 13 wherein the step of suspending the particular virtual node saves the disk image on the shared storage.

15. The method of claim 13 wherein the step of suspending the particular virtual node compresses the disk image, thereby forming a compressed disk image, and saves the compressed disk image on the shared storage media.

16. The method of claim 13 further comprising the step of setting bits to a regular pattern state for at least a portion of the local storage media after suspending the virtual node.

17. The method of claim 16 further comprising the step of resuming the particular virtual node on the first computer which writes the disk image onto the local storage media, wherein particular bits within the disk image having the regular pattern state are not written to the local storage media.

18. The method of claim 13 further comprising the step of identifying state changes between the node state and the modified state and transferring the state changes to the shared storage media.

19. The method of claim 12 wherein the node state comprises an initial state.

20. The method of claim 19 wherein the node state further comprises a state delta, the modified state comprises the initial state and a modified state delta, and the step of suspending the particular virtual node saves the modified state on the shared storage media by transferring the modified state delta to the shared storage media and storing the modified state delta on the shared storage media.

21. The method of claim 20 further comprising the step of re-loading the particular virtual node onto the computer which comprises transferring a standard state and the modified state delta to the computer, the standard state comprising a base operating system and base applications for other virtual nodes.

22. The method of claim 20 wherein the shared storage media retains the state delta.

23. The method of claim 12 further comprising the step of removing the disk image from the local storage media.

24. The method of claim 1 further comprising the step of using a trusted computing module to verify a validity of transitions within the steps of loading the particular virtual node to the first computer and suspending the particular virtual node.

25. A computer readable memory comprising computer code for implementing a method of sharing access to a cluster of computers, the method of sharing access to the cluster of computer comprising the steps of:
identifying a particular user from within a group of users;
loading a particular virtual node for the particular user onto a first computer, the particular virtual node comprising one of a plurality of virtual nodes for the group of users, each of the plurality of virtual nodes comprising an operating system selected from a range of operating systems and one or more applications;
operating the particular virtual node which changes a node state, thereby forming a modified state; and
suspending the particular virtual node which saves the modified state, closes the virtual node, and idles the first computer.

26. The method of claim 25 wherein the particular virtual node further comprises one or more configuration options.

27. A computer system comprising:
a plurality of computers coupled together, each computer comprising a local storage;
a shared storage coupled to the plurality of computers; and
a node manager coupled to the plurality of computers such that in operation:
a particular computer begins in an idle mode;
a user selects the particular computer causing the node manager to load a disk image of a virtual node from the shared storage onto the local storage, the virtual node comprising an operating system and one or more applications for the user;
the user operates the virtual node which modifies a node state, thereby forming a modified state; and
the user releases the particular computer causing the node manager to transfer the disk image of the virtual node in the modified state to the shared storage.

28. The computer system of claim 27 wherein a first computer further comprises a primary processor.

29. The computer system of claim 28 wherein the first computer further comprises a service processor.

30. The computer system of claim 27 wherein the user selects the particular computer by logging-on to the particular computer.

31. The computer system of claim 27 wherein the user selects the particular computer by clicking an object on a web site.

32. The computer system of claim 27 wherein the user selects the particular computer by making a selection from an interface to an application.

33. The computer system of claim 27 wherein the user selects the particular computer by providing a physical object to a physical object reader.

34. The computer system of claim 33 wherein the physical object comprises an identification badge.

35. The computer system of claim 33 wherein the physical object comprises a biometric attribute of the user.

36. The computer system of claim 35 wherein the biometric attribute comprises a first biometric attribute which is selected from a group consisting of an iris, a retina, a fingerprint, another biometric attribute, and a combination thereof.
